(19) United States
(12) Patent Application Publication
(10) Pub. No.: US 2022/0312782 A1
(43) Pub. Date: Oct. 6, 2022

(54) EDIBLE COMPOSITION TO PROLONG THE SHELF LIFE OF FOOD PRODUCTS

(71) Applicant: KING FAISAL UNIVERSITY, AL-AHSA (SA)

(72) Inventors: SAHAR MOSTAFA KAMEL SALEM, AL-AHSA (SA); HAYA SAMI SALEM AL-TAEBAH, AL-AHSA (SA)

(21) Appl. No.: 17/221,277

(22) Filed: Apr. 2, 2021

(51) Int. Cl. A23B 4/20; A23B 4/08

(52) U.S. Cl. CPC A23B 4/20; A23B 4/08

(57) ABSTRACT

An edible composition to prolong the shelf-life of food products can include gum arabic and date pits extract. The edible composition can be applied to a food product to preserve the food product. For example, the edible composition can protect the food product from bacterial growth, loss of moisture, and/or oxidation. In an embodiment, the edible composition can be applied to the food product prior to refrigeration to increase the shelf-life of the food product. For example, the food product with the edible composition applied thereon, can be refrigerated at a temperature of about 4° C. in order to increase the shelf-life of the food product. The food product can include at least one of a meat product, a fruit product, and a vegetable product. The meat product can include, e.g., chicken, beef, or lamb. In an embodiment, the meat product is chicken.

### BACKGROUND

### 1. Field

The disclosure of the present patent application relates to food preservatives, and particularly, to an edible composition for increasing the shelf-life of food products.

### 2. Description of the Related Art

With many food products, including meat, it is necessary to rapidly package and refrigerate the material. If the food product is not packaged or refrigerated soon enough, deterioration may result. Typically, deterioration results from a rapid and undesirable increase in the bacterial count of the product, cell damage, or fat oxidation.

Chicken meat is considered one of the most consumed meats in the world because of its high nutritional value. Chicken meat contains high-quality protein and many other nutrients that are necessary for survival. Because of its chemical and biological nature, however, chicken meat is particularly vulnerable to damage if adequate care is not taken during packaging and/or storage. For example, improper storage of chicken meat can cause oxidation of fat, bacterial growth, and/or odor. Thus, improper storage of chicken meat can affect the quality and suitability of the meat for human consumption.

Thus, a composition for increasing the shelf-life of food products solving the aforementioned problems is desired.

### SUMMARY

An edible composition to prolong the shelf-life of food products can include gum arabic and date pit extract. The edible composition can be applied to a food product to preserve the food product. For example, the edible composition can protect the food product from bacterial growth, loss of moisture, and/or oxidation. In an embodiment, the edible composition can be applied to the food product prior to refrigeration to increase the shelf-life of the food product. For example, the food product with the edible composition applied thereon, can be refrigerated at a temperature of about 4° C. in order to increase the shelf-life of the food product. The food product can include at least one of a meat product, a fruit product, and a vegetable product. The meat product can include, e.g., chicken, beef, or lamb. In an embodiment, the meat product is chicken.

These and other features of the present disclosure will become readily apparent upon further review of the following specification.

### DETAILED DESCRIPTION OF THE PREFERRED EMBODIMENTS

An edible composition to prolong the shelf-life of food products can include gum arabic and date pit extract. The edible composition can be applied to a food product to preserve the food product. For example, the edible composition can protect the food product from bacterial growth, loss of moisture, and/or oxidation. In an embodiment, the edible composition can be applied to the food product prior to refrigeration to increase the shelf-life of the food product. For example, the food product with the edible composition applied thereon, can be refrigerated at a temperature of about 4° C. in order to increase the shelf-life of the food product. The food product can include at least one of a meat product, a fish product, a fruit, and a vegetable. The meat can include chicken, beef, or lamb. In an embodiment, the meat product is chicken meat.

The edible composition can be prepared by mixing powdered date pits in a solution of gum arabic to provide a mixture. The powdered date pits can be prepared by soaking the date pits in water, drying the date pits, and then grinding the date pits to provide a powder. The mixture can include about 0.2% powdered date pits and about 15% gum arabic. The mixture can be heated to a temperature of about 90° C. and then cooled to provide the edible composition. In an embodiment, the mixture can be heated to a temperature of about 90° C. and then cooled to a temperature of about 4° C.

The phrase “gum arabic,” as used herein, refers to the natural gum derived from the sap of certain wild trees, e.g., certain species of the acacia tree, found mainly in Sudan and some other parts of Africa. The sap includes a mixture of glycoproteins and polysaccharides. Gum arabic is edible and soluble in water. The phrase “date pits,” as used herein, refers to the oblong, hard seed of the Date Palm fruit or date. Date pits have a high total phenol content and high antioxidant activity.

In an embodiment, chicken pieces can be coated with the edible composition and then chilled or refrigerated, for example at about 4° C. In an embodiment, the chicken pieces can be immersed in the edible composition for a period of time, e.g., about 1 minute, then drained and packaged for storage. In an embodiment, the chicken pieces can be packaged by placing the chicken pieces on foam plates and covering the chicken pieces with polyethylene. The packaged chicken can be stored at about 4° C. for about 14 days without deterioration.

As described herein, chicken pieces coated with the edible composition retained a greater amount of moisture content and weight after 14 days of refrigeration compared to a control sample of chicken pieces that were not coated with the edible composition (herein, “uncoated control sample”). Further, the chicken pieces coated with the edible composition demonstrated greater anti-microbial and antioxidant activities and provided greater protection against lipid oxidation (TBA) than the control samples after two weeks of refrigeration. The pH of the coated chicken pieces prior to storage was not significantly different than the pH of the coated chicken at the end of the storage period. When the coated chicken pieces were cooked, the coated chicken pieces were better than the control in taste and tenderness. Further, after conducting a texture analysis using a texture profile analyzer, the degree of hardness, chewiness, gumminess, and cohesiveness of the coated chicken pieces was significantly less than the control group.

The following examples illustrate the present teachings.

### Example 1

### Analysis of Date Pits and Gum Arabic

The total phenol content and antioxidant activity of date pits and gum arabic were tested. As shown in Tables 1 and 2, respectively, date pits have a higher total phenol content and antioxidant activity than gum arabic.

TABLE 1
Total phenols mg/g as gallic acid

| Days | 0 | 7 | 14 |
|---|---|---|---|
| Gum Arabic | 8.94 ± 0.45 | 14.67 ± 0.49 | 16.33 ± 0.85 |
| Date pits | 180.25 ± 10.61 | 151.94 ± 3.80 | 152.12 ± 4.08 |

TABLE 2
Anti-oxidant Activity

| Days | 0 | 7 | 14 |
|---|---|---|---|
| Gum Arabic | 8.33 ± 0.17 | 7.57 ± 0.19 | 5.09 ± 0.47 |
| Date pits | 86.18 ± 0.18 | 84.11 ± 0.30 | 84.34 ± 0.95 |

The viscosity data for a solution of gum arabic and a solution of date pits is provided in Table 3.

TABLE 3
Viscosity (mPa · s)

| Days | 0 | 7 | 14 |
|---|---|---|---|
| Gum Arabic sol. | 63.17 ± 1.25 | 63.17 ± 0.28 | 63.50 ± 0.0 |
| Date pits sol. | 63.83 ± 0.28 | 66.83 ± 0.28 | 66.83 ± 0.28 |

### Example 2

### Refrigerated Raw Chicken Meat

The edible composition to prolong the shelf-life of food products was prepared by mixing a solution of gum arabic with powdered date pits to provide a mixture including 15% gum arabic and 0.2% palm date pits, heating the mixture to 90° C., then cooling the mixture to 4° C. The composition was then applied to raw chicken meat by immersing the chicken pieces in the composition for 1 minute and then allowing excess composition to drain from the chicken pieces for 15 minutes. The chicken pieces coated with the edible composition were packaged in foam plates, covered with polyethylene, and stored at 4° C. for 14 days.

The content of thiobarbituric acid reactive substances (TBARS) in raw chicken meat was determined for uncoated meat, meat coated with gum arabic, and meat coated with the edible composition (gum arabic+date pits) before refrigeration (0 days), 7 days after refrigeration, and 14 days after refrigeration. The results are provided in Table 4.

TABLE 4

| Days | 0 | 7 | 14 |
|---|---|---|---|
| Control | 0.80 ± 0.02 | 0.83 ± 0.03 | 1.62 ± 0.03 |
| Gum Arabic | 0.72 ± 0.01 | 0.02 ± 1.02 | 1.09 ± 0.20 |
| Gum Arabic + | 0.62 ± 0.0 | 0.70 ± 0.03 | 0.76 ± 0.06 |
| Date pits | | | |

LSD = 0.1405

The extent of microbial growth on refrigerated raw chicken meat was determined for uncoated meat, meat coated with gum arabic, and meat coated with the edible composition (gum arabic+date pits) (optical density 600 nm). The results are provided in Table 5.

TABLE 5

| | |
|---|---|
| Control | 0.112 ± 0.00 |
| Gum Arabic | 0.098 ± 0.01 |
| Gum Arabic + | 0.089 ± 0.00 |
| Date pits | |

LSD 0.01

The extent of moisture loss in refrigerated raw chicken meat was determined for uncoated meat, meat coated with gum arabic, and meat coated with the edible composition (gum arabic+date pits) after 14 days of refrigeration. The results are provided in Table 6.

TABLE 6

| | Weight loss % | Moisture loss % |
|---|---|---|
| Control | 12.95 ± 0.59 | 4.84 ± 0.11 |
| Gum Arabic | 10.92 ± 0.43 | 0.74 ± 0.01 |
| Gum Arabic + | 9.60 ± 0.43 | 1.67 ± 0.07 |
| Date pits | | |
| LSD | 1.02 | 0.11 |

### Example 3

### Cooked Chicken Meat

The uncoated meat, the meat coated with gum arabic, and the meat coated with the edible composition (gum arabic+date pits) was cooked after 14 days of refrigeration. The extent of weight loss and moisture loss was then determined and the results are provided in Table 7. The cooked chicken pieces coated with the edible composition further demonstrated acceptable sensory characteristics, as shown in Table 8.

TABLE 7

| | Weight loss % | Moisture loss % |
|---|---|---|
| Control | 40.81 ± 1.49 | 22.91 ± 0.04 |
| Gum Arabic | 31.68 ± 2.36 | 15.53 ± 0.00 |
| Gum Arabic + | 37.64 ± 0.79 | 15.45 ± 0.47 |
| Date pits | | |
| LSD | 2.09 | 0.11 |

TABLE 8

| | | | | | Overall |
|---|---|---|---|---|---|
| | Color | Odor | Tenderness | Taste | acceptability |
| Control | 6.27 ± 1.48 | 5.87 ± 2.03 | 6.07 ± 1.43 | 7.53 ± 1.92 | 6.20 ± 1.47 |
| Gum Arabic | 6.87 ± 1.18 | 6.33 ± 2.02 | 0.91 ± 7.13 | 7.87 ± 1.45 | 7.40 ± 0.98 |
| Gum Arabic + | 7.13 ± 1.64 | 6.67 ± 1.54 | 7.20 ± 1.47 | 7.07 ± 1.43 | 7.27 ± 1.27 |
| Date Pits | | | | | |

It is to be understood that the composition is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An edible composition to prolong the shelf-life of food products, comprising:
date pit extract; and
gum arabic.

2. A method of preparing an edible composition to prolong the shelf-life of food products, comprising:
providing a solution of gum arabic;
adding powdered date pits to the solution of gum arabic to provide a mixture comprising about 15% gum arabic and about 0.2% date palm pits;
heating the mixture to a temperature of about 90° C. to provide a heated mixture; and
cooling the heated mixture to provide the edible composition.

3. The method of claim 2, wherein the heated mixture is cooled to a temperature of about 4° C.

4. An edible composition prepared according to the method of claim 2.

5. A method for prolonging the shelf-life of food products, comprising applying an edible composition to a food product, the edible composition being prepared by adding powdered date pits to a solution of gum arabic to provide a mixture comprising about 15% gum arabic and about 0.2% date palm pits; heating the mixture to a temperature of about 90° C. to provide a heated mixture; and cooling the heated mixture to provide the edible composition.

6. The method of claim 5, wherein the food product comprises at least one of a fish, a meat, a fruit, and a vegetable.

7. The method of claim 6, wherein the meat is selected from chicken, lamb, and beef.

8. The method of claim 7, wherein the meat is chicken.

9. The method of claim 5, further comprising refrigerating the food product after applying the composition.

10. The method of claim 9, wherein the food product is refrigerated at a temperature of 4° C.
